(19) United States
(12) Patent Application Publication
(10) Pub. No.: US 2017/0345032 A1
(43) Pub. Date: Nov. 30, 2017

(54) AUTOMATIC AUDIENCE CREATION BY SCORING USERS, AND OPTIMIZING CREATED AUDIENCES

(71) Applicant: Google Inc, Mountain View, CA (US)

(72) Inventors: Fernando Altomare Serboncini, Zurich (CH); Effrosyni Kokiopoulou, Adliswil (CH); Dimitre Trendafilov, Wollerau (CH)

(21) Appl. No.: 13/930,690

(22) Filed: Jun. 28, 2013

(51) Int. Cl. G06Q 30/02

(52) U.S. Cl. CPC G06Q 30/0204

(57) ABSTRACT

A system and method for automatic audience creation by scoring users of a content sharing service is provided. The system includes a user analysis module to monitor data associated with the users of the content sharing service; and a channel analysis module to monitor data associated with a first channel; a scoring module to score, based on the monitored data associated with users and the first channel, each user based on a ratio of views versus accesses for shared content sourced from the first channel; and an audience assignment module to create an audience for the first channel of users with scores above a predetermined threshold.

### BACKGROUND

Content sharing services serve content, such as pictures, videos, text, or combinations thereof, to users who access the content sharing service. The content may be sourced from a publisher, automatically generated, or from upload by one of the users. The content sharing service may store the content, or link to other services, and subsequently retrieve the content prior to serving the content to the users.

The content sharing service may augment the serving of the content with shared content. The shared content may be served before, during and after the presentation of the content. The shared content may be associated with meta information, and when the shared content is clicked-through by a user, the user may be redirected to additional content associated with the shared content. The shared content may provide information associated with a product or service related to the content.

In certain implementations, the shared content may be presented along with a functional input to bypass the serving of the shared content. By providing the functional input to bypass the serving of the shared content, the content sharing service ensures that a user is not served shared content that the user is not interested in consuming.

A user may be served shared content from the content sharing service based on prior activities. For example, if a content publisher sources a group of videos, and the user has accessed one or more of the publishers videos, the user may be served shared content sourced from the publisher based on the users previous activities.

A user may be served shared content based on the users similarity to another user. For example, if a users viewing preference matches or is similar to another users viewing, preference, the user may be served shared content based on the other user's content accessed.

Other techniques employ keyword and interest metrics. The content sharing service may serve shared content based on a keyword search that a user employs to find and retrieve content. Additionally, the content viewed by the user may be associated with a specific interest or category. The content sharing service may serve shared content based on the specific interest or category that the user has shown interest in.

The content sharing service may monetize the serving of shared content to users. Accordingly, a third-party associated with the subject matter of the shared content may direct the content sharing service to serve users the shared content.

The content sharing service may monetize the serving of shared content by promising a specific number of views or accesses by the users. In doing so, the content sharing service may assess a charge per shared content in which the user does not access the bypass function (“views”), or in which a user clicks-through the shared content. Thus, the third-party may ensure that it is paying primarily for views in which the user fully consumed (i.e. did not enable the bypass function) the third-party's shared content.

Additionally, the third-party may request that shared content (or a group of shared content items) be served along with a budget restraint. The budget restraint may represent a limit that the third-party is willing to spend for a specific time period for the serving of shared content. Thus, the content sharing service may ensure that for the specific time period, the third-party's shared content will not be served to more users than the third-party's requested budget restraint allows for.

### SUMMARY

A system and method for automatic audience creation by scoring users of a content sharing service is provided. The system includes a user analysis module to monitor data associated with the users of the content sharing service; and a channel analysis module to monitor data associated with a first channel; a scoring module to score, based on the monitored data associated with users and the first channel, each user based on a ratio of views versus accesses for shared content sourced from the first channel; and an audience assignment module to create an audience for the first channel of users with scores above a predetermined threshold.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example of a system for automatic audience creation by scoring users.

FIG. 3 illustrates an example of a method for automatic audience creation by scoring users.

FIG. 4 illustrates an example of a method for optimizing a created audience.

FIG. 5 illustrates an example of a method for optimizing a created audience based on a metric.

### DETAILED DESCRIPTION

A content sharing service may be configured to employ techniques for improving the click-through rate of shared content served along with other content. The content sharing service may monetize the serving of shared content and receive compensation commensurate with the amount of times the shared content is clicked through. The shared content may be served along with a bypass function that allows a user to bypass the viewing of the shared content after a predetermined time. The compensation associated with the shared content may be set commensurate with the number of times the user does not access the bypass function, and thus consumes all of, or a significant portion of, the shared content. A view may be classified as a situation in which a user consumes all, or an amount over a predefined threshold, of the shared content. Accordingly, the content sharing service may monetize content or shared content commensurate with the view numbers associated with the content or shared content.

Third parties that are affiliated with, or source shared content may affix a budgetary restraint along with the serving of shared content (or a group of shared content items). For example, a third-party may request that the third-party's shared content is served under a budget of X dollars for every hour. If each view is charged at a rate of X/1,000 dollars, the content sharing service may serve the shared content 1,000 times during every Y hour.

In the above example, the content sharing service may only record instances in which the user views the shared content when applying a charge to the third-party. Thus, there is no guarantee that the content sharing service reaches the 1,000 views mandated by the third-party's budget.

If the content sharing service is configured to randomly serve the shared content to the content sharing service's user base as a whole, there may be instances where not enough users view the shared content during the time period affixed to the third-party's budgetary restraint.

Disclosed herein are methods and system for automatic audience creation by scoring users. The methods and systems discussed herein employ data collection associated with each user's interaction with the content sharing service over a time period.

Each user is assigned a score based on the user's likelihood of viewing shared content. The scoring may be determined through prior knowledge and learning models based on each user's interaction with the content sharing service.

After each user is given a score based on the users likelihood of viewing shared content, the users are assigned to a third-party's shared content audience. In cases when the content sharing service serves the third-party's shared content, the content sharing service may exclusively serve the shared content to users in the third-party's audience.

The above-described determination may be improved by analyzing a channel associated with the third-party. A channel is a group of content items or shared contents items associated with the third-party. Thus, the subset of users may further be refined to users that are subscribed to the third-party's channel.

The audience creation may be improved by dynamic adjustments performed iteratively. After a predetermined time has elapsed, the content sharing service may be configured to analyze the success of the created audience at satisfying the third-party's budget. An initial threshold may be used to create an initial audience. The initial threshold may mandate that users with a certain score constitute the audience associated with the third-party's shared content.

After performing an analysis after the predetermined time elapses, the content sharing service may determine that the initially created audience does not produce enough views. Accordingly, the threshold for a score required to be an audience member is increased, thereby allowing less users to be included in the audience. As these remaining users have the highest likelihood of producing a view, the content sharing service increases the likelihood that the third party's shared content will be viewed.

Conversely, if the analysis indicates that number of views satisfies the third-party's budget at a time less than the time interval, the content sharing service may lower the threshold score used. Accordingly, the number of users who constitute the third party's audience is increased. Thus, every time shared content is served to an audience member, the likelihood of the audience member viewing the shared content is reduced.

Another aspect to the systems and methods disclosed herein is that users who exhibit scores over a threshold for multiple third-party shared content sources are deliberately assigned to specific third-party audiences. For example, if the user exhibits scores to warrant membership to ten third-party audiences, and the content sharing service mandates that each user only be assigned to six third-party audiences, the systems and methods disclosed herein may determine the six specific third party audiences that the user is assigned to. The deliberate assignation is done to ensure that the content sharing service serves shared content to users in a way to maximize revenue.

By providing an automatic creation of an audience, the onus of creating an audience is removed from a third-party. Further, by employing the techniques herein, the third-party may realize the serving of shared content with greater rates of click-through and more views. Thus, the third-party's shared content is less likely to be served to a user who is not interested in the shared content.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

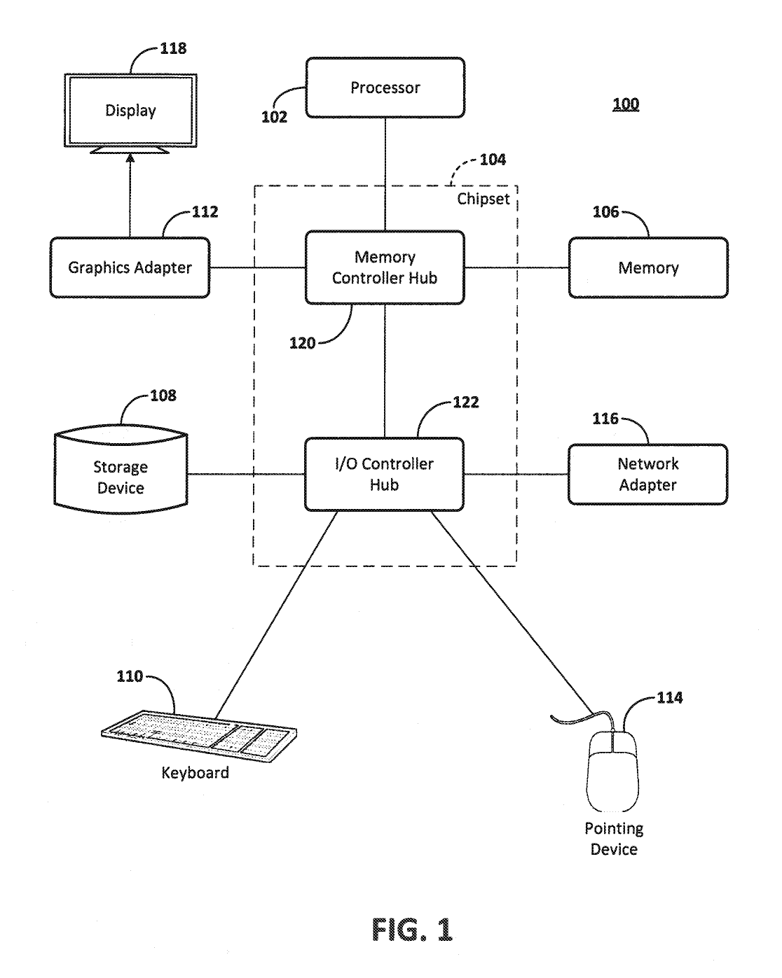

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 105 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing, functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 108, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network 250.

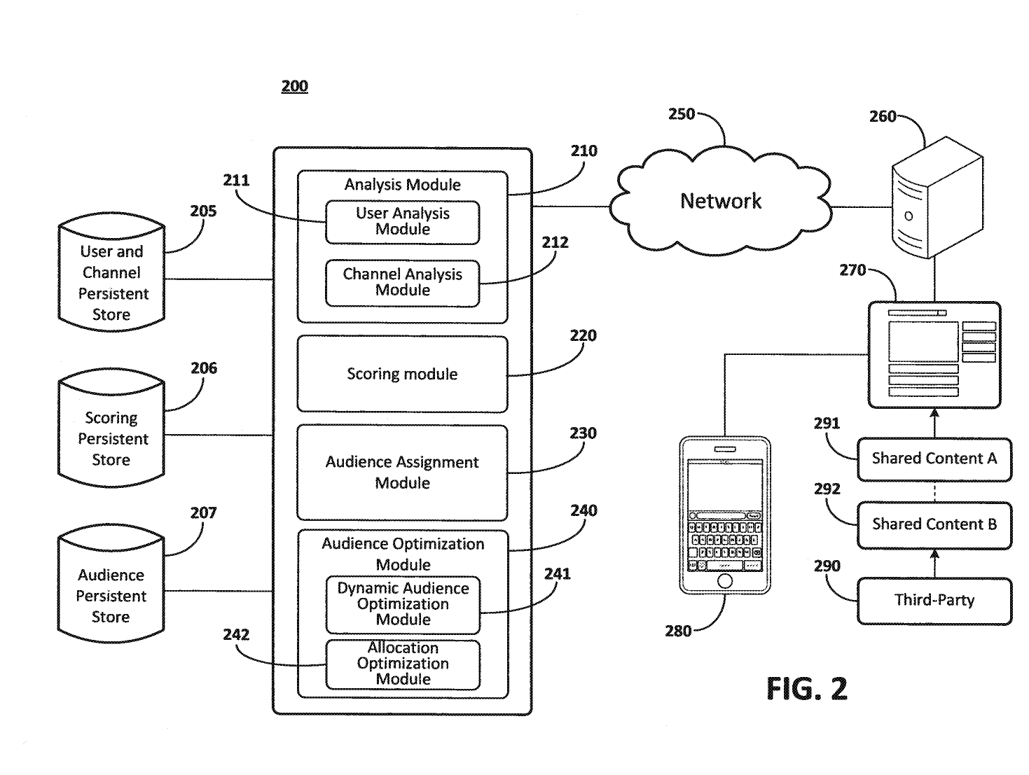

FIG. 2 illustrates an example of system for automatic audience creation by scoring users. The system 200 includes an analysis module 210, a scoring module 220, an audience assignment module 230, and an audience optimization module 240. As illustrated in FIG. 2, the system 200 communicates via network 250 to a server 260. The server 260 hosts a content sharing service 270. The server 260 and system 200 may be implemented on a device, such as computer 100.

The content sharing service 270 serves content to devices that access the content sharing service 270 over the network 250, such as user device 280.

Some of the content or shared content that the content sharing service 270 serves may be sourced from a third-party 290. The third party 290 sources content or shared content, such as shared content A 291 and shared content B 292. Content and shared content sourced from third-party 290 may be presented as a channel of the third-party 290.

The analysis module 210 includes a user analysis module 211 and a channel analysis module 212. The user analysis module 211 monitors a subset of users associated with the content sharing service 270. Thus, each access to the content sharing service 270 may be monitored in several ways, such as the content accessed by each user, the shared content viewed by each user, and the shared content bypassed by each user, for example.

The channel analysis module 212 monitors accesses to various channels demarcated on the content sharing service 270. A channel may be associated with a specific third-party. Accordingly, the channel analysis module 212 may monitor accesses to the content or, shared content associated with the specific third-party that constitutes a channel.

The user analysis module 211 and the channel analysis module 212 may interact with a user and channel persistent store 205 to retrieve information about the various users and channels registered on the content sharing source 270.

The analysis module 210 may correlate the monitored data of each user for specific channels. Thus, the analysis module 210 may maintain data indicating each user's interaction with content or shared content associated with a specific channel. For example, if a user ‘A’ is served content or shared content associated with a specific third-party, the analysis module 210 may maintain a recordation for user ‘A’ associated with the access to third-party's content or shared content. Further, analysis module 210 may maintain a recordation of instances in which the user viewed or bypassed the shared content for a particular channel.

The scoring module 220 assigns a score to each user based on the data sourced from the analysis module 210. The score serves to provide a metric that allows the content sharing service 270 to predicatively analyze a probability that the user views the shared content. The score may be based on the ratio of the number of user views versus the number of user accesses for content or shared content sourced from the third-party's channel.

The scoring module 220 may assign a score to each user per channel. The scores may be stored in a scoring persistent store 206. The score essentially serves as an indication of a user's likelihood to view content or shared content sourced from a third-party.

The audience assignment module 230 creates an audience for each channel. System 200 may be configured with a predetermined initial audience number. The predetermined initial audience number may be set through various ways, such as by an algorithm employed by system 200, or a manually chosen number, for example.

For example, if the predetermined initial audience number is 100, the shared content associated with a channel is only served to the 100 users with the highest score for the channel. Thus, the 100 users with the highest likelihood of viewing shared content from a specific channel ere exclusively served, shared content associated with the channel. A recordation of the created audience for each channel may be stored in the audience persistent store 207.

The audience optimization module 240 optimizes the assigned audiences for each channel. The audience optimization module 240 includes a dynamic audience optimization module 241 and an allocation optimization module 242.

The dynamic audience optimization module 241 performs an operation to optimize the created audiences at a predetermined time interval. At each predetermined time interval, a determination may be made as to whether the created audience per each channel is optimally set. For example, if a ratio between user views versus user accesses of content or shared content associated with the channel is below a predetermined threshold, a determination may be made that the created audience may be reduced in size.

The predetermined threshold employed by the dynamic audience optimization module 241 may be related to the budgetary restraint associated with the third-party. Thus, the ratio calculate above may help predict whether the created audience is effective in using the third-party's budget for a predetermined time period.

The dynamic audience optimization module 241 may determine the ratio between user views versus user accesses of content or shared content associated with the channel over the predetermined threshold. Accordingly, the created audience may be increased in size (i.e. a lesser score may be required for a user to be added to an audience). In this way, the audience may be greater in size, while ensuring that the shared content sufficiently gets viewed during a specific time period.

Additionally, if there is no change in the above-noted ratio, the dynamic audience optimization module 241 may maintain the audience size.

The allocation optimization module 242 determines resolves conflicts in cases where a specific user is assigned to audiences of various channels over a predefined amount that the implementer of the content sharing service 270 has set. For example, if the specific user scores well enough to be assigned to twenty different channels, and the system 200 is configured to allow each user to be assigned only to ten channels, the allocation optimization module 242 determines which ten channels the user is assigned to.

An example metric for assigning the user to various audiences is to employ a monetization basis. This metric may be based on predicatively observing which assignment generates the highest revenue.

For example, the following expression may be used to calculate a ranking for a specific user for a specific channel. The expression is defined as:

RPMu=1000*CPC*VTR*e;

wherein RPMu is defined as revenue per thousand users,

CPC is defined as the cost-per-click (i.e. the money generated per clicking shared content from the specific channel by the specific user),

VTR is defined as the view-through-rate (i.e. the score for the specific user for the specific channel), and

e=(1000*number of views by all users of the specific channel)/(number of users associated with the specific channel).

After calculating the RPMu for each channel that the specific user is associated with, the channels with the highest RPMu may constitute the set of audiences in which the specific user belongs to.

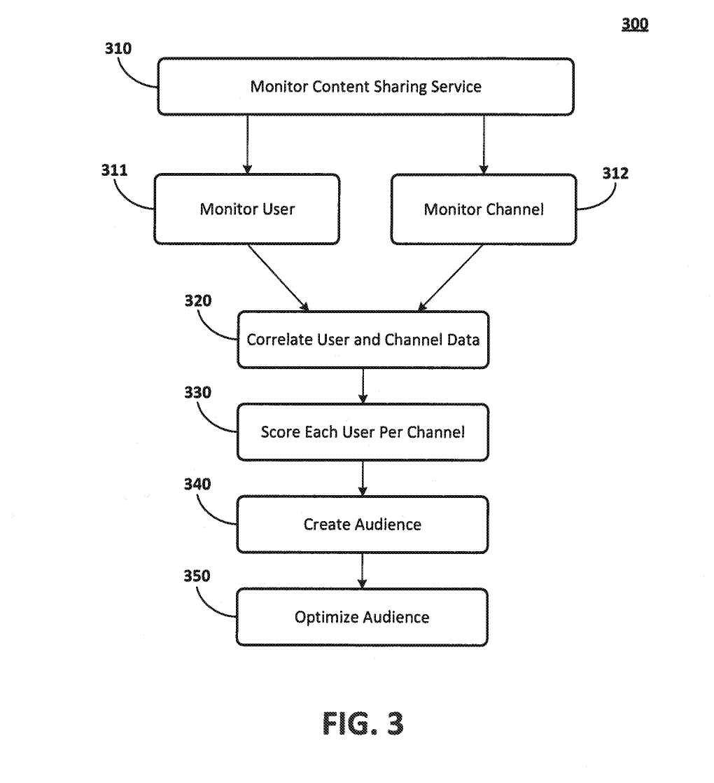

FIG. 3 illustrates an example of a method 300 for automatic audience creation by scoring users. The method 300 may be implemented on the system 200 depicted in FIG. 2.

In operation 310, a content sharing service 270 is monitored. Various aspects of the content sharing service 270 are monitored, such as each user's activity on the content sharing service 270 (operation 311), activity on each channel (operation 312), for example. Operations 311 and 312 may be performed in parallel.

Specifically, in operation 311, the user's viewing of content or shared content versus the user's accessing of content or shared content is recorded. In operation 312, activity associated with the channel, such as content or shared content that is viewed versus content or shared content that is accessed is recorded.

In operation 320, the data recorded in operations 311 and 312 are correlated. For each user, a record of the respective user is made per channel of the content or shared content the respective user viewed and accessed.

In operation 330, a score for each user per channel is computed. The score corresponds to the ratio of the user's viewing of content or shared content versus accessing content or shared content. A higher ratio corresponds to a higher score.

In operation 340, based on the computed scores of operation 330, an audience is created for a channel. If the operator of the channel, or the operator of content sharing service 270 designate that a channel be assigned an audience according to method 300, the channel is assigned to a predefined number of users with the highest computed score for the channel. The predefined number may be set based on a number deemed appropriate for an initial audience creation. As explained in operation 350 below, the number of users assigned to a channel's audience may be updated to be greater or lesser based on a dynamic operation.

In operation 350, the audience created in operation 340 is optimized. The optimization may be performed via a plurality of techniques, several of which that are further elaborated below in regards to method 400 and method 500.

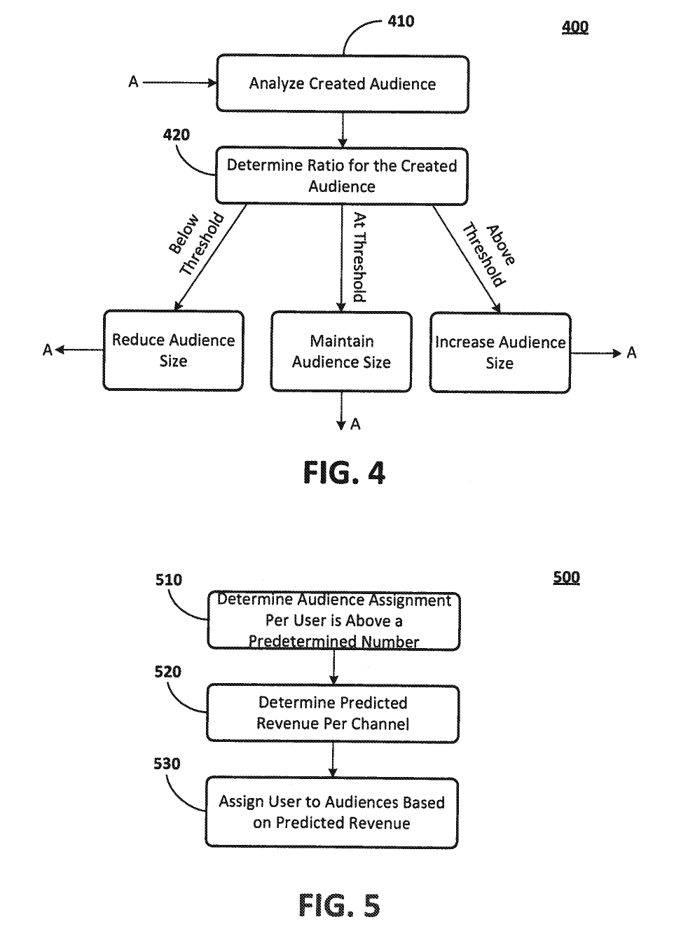

FIG. 4 illustrates an example of a method 400 for optimizing a created audience. The method 400 may be implemented on the system 200 depicted in FIG. 2. The method 400 may be performed during operation 350 of method 300.

In operation 410, at a predetermined time interval, a created audience for a channel is analyzed. The predetermined time interval may be determined by the operator of the content sharing service 270 or by a third-party associated with the channel being analyzed. Method 400 is performed iteratively at every predetermined interval after an initial audience for a channel is created.

In operation 420, a ratio of the views versus access of content or shared content sourced for the channel is determined. After this determination is made, the membership of the created audience for the channel may be adjusted accordingly based on operations 421-423.

In operation 421, if the ratio is below a predetermined threshold (an example of the establishment of the predetermined threshold is described above in regards to element 241), the created audience size is lessened. The created audience size may be lessened by increasing a score required to be a member of the created audience.

Essentially, a ratio below the threshold indicates that users are accessing shared content, but not viewing the shared content. Thus, the budget associated with the channel's shared content is not used. By having a smaller audience who are more likely to view the content or shared content associated with the channel, the budget associated with the channel may be used fully.

In operation 422, if the ratio is within an acceptable range, the created audience size is maintained.

In operation 423, if the ratio is above the predetermined threshold, the created audience size is made larger. Converse to operation 421, the created audience size may be made larger by lowering the score required to be an audience member of the channel.

The justification for performing operation 423 is that the ratio indicates that the users are viewing the shared content at a rate that may exceed the allocated budget for a time period. For example, the budget for the time period may be used in its entirety well before the time period elapses. In this way, the third-party associated with the shared content does not realize an evenly spread distribution of the third party's shared content over the time period.

After operations 421-423, the method may iteratively return to operation 410 at the predetermined time interval. Method 400 ensures that the created audience per channel is dynamically optimized so that the created audience's size matches a third-party's budgetary restraint for shared content distribution.

FIG. 5 illustrates an example of a method 500 for optimizing an audience based on a metric. The method 500 may be implemented on the system 200 depicted in FIG. 2. The method 500 may be performed during operation 350 of method 300.

In operation 510, a determination is made per user if the user is assigned to more than a predetermined number of audiences. For example, a user may have a high enough score to be assigned to twenty audiences. The implementation of content sharing service 270 may mandate that each user be assigned to only ten audiences or less. In this example, the method 500 would proceed to operation 520.

In operation 520, a determination is made to predict the revenue the user would generate per each audience the user is assigned to. This determination may employ the formula to computer the RPMu per channel described above in regards to element 242 of system 200.

In operation 530, the user is assigned to the predetermined number of audiences based on the determined predicted revenues of operation 520. In the example noted above, the user would be assigned to the ten audiences with the highest RPMu values.

According to method 500, an implementation of system 200 may ensure that users of the content sharing service 270 are assigned to a predetermined number of audiences in a way to maximize revenue.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 3-5. The disclosed devices, components, and systems contemplate using or implementing any suitable technique for performing the steps illustrated in these figures. Thus, FIGS. 3-5 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in, question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

1. A system comprising:
a memory; and
a processor, coupled to the memory, to:
provide a plurality of channels available to be viewed by any users of a plurality of users of a content sharing service;
detect interactions of first users of the plurality of users of the content sharing service with the content sharing service, the content sharing service comprising the plurality of channels, the plurality of channels comprising video content uploaded to the content sharing service by second users of the plurality of users and at least one of the first users of the plurality of users of the content sharing service for presentation to the first users of the content sharing service;
detect interactions of the first users with a first channel of the plurality of channels of the content sharing service, the first channel presenting video content items sourced from the content sharing service and shared content sourced from a third party system, the interactions of the first users with the first channel comprising viewing the shared content and bypassing the shared content being viewed;
determine, based on the interactions of the first users with the content sharing service and the interactions of the first users with the first channel, a score for each first user, wherein the determining of the score is improved by further using a ratio of views versus accesses for the shared content sourced from the third party system and presented via the first channel;
create an audience for the first channel by selecting a subset of the first users with scores above a predetermined threshold, wherein the creating of the audience is improved by further selecting each user of the subset of the first users based on a number of channels for which each user is part of an audience; and
present, via a graphical user interface, (a) one or more video content items sourced from the content sharing service to any users of the plurality of users as part of the first channel, and (b) one or more shared content sourced from the third party system to users of the audience as part of the first channel.

2. The system according to claim 1, wherein the processor is further to:
update a size of the created audience at a predetermined time interval.

3. The system according to claim 2, wherein the processor is further to recreate the audience based on an updated predetermined threshold.

4. The system according to claim 3, wherein the updated predetermined threshold is based on the first channel's budgetary restraint.

5. The system according to claim 4, wherein in response to the ratio being above the predetermined threshold, the updated predetermined threshold is made to be larger than the predetermined threshold, and
in response to the ratio being below the predetermined threshold, the updated predetermined threshold is made to be smaller than the predetermined threshold.

6. The system according to claim 1, wherein the processor is further to:
determine that a number of channels for which a first user is part of an audience exceeds a threshold number of channels;
identify which channels of the plurality of channels the first user is part of the audience to responsive to determining that the number of channels for which the first user is part of the audience exceeds the threshold number of channels.

7. The system according to claim 6, wherein the channels for which the first user is part of the audience are identified based on a revenue determination per channel.

8. The system according to claim 7, wherein the revenue determination per channel is based on a cost-per click of the channel's shared content, the score of the first user for the channel, and ratio of a number of views of the first users of the channel and a number of accesses of the first users of the channel.

9. A method comprising:
providing a plurality of channels available to be viewed by any users of a plurality of users of a content sharing service;
detecting, by a processor, interactions of first users of the plurality of users with the content sharing service and interactions of the first users with a first channel of the plurality of channels of the content sharing service, the content sharing service comprising the plurality of channels, the plurality of channels comprising video content uploaded to the content sharing service by second users of the plurality of users and at least one of the first users of the plurality of users of the content sharing service for presentation to the first users of the content sharing service, the first channel presenting video content items sourced from the content sharing service and shared content sourced from a third party system;
correlating, by the processor, the interactions of the first users with the content sharing service and the interactions of the first users with the first channel to record data indicating each first user's views and accesses to content or shared content sourced from the first channel, the interactions of the first users with the first channel comprising viewing the shared content and bypassing the shared content being viewed;
determining, by the processor based on the interactions of the first users with the content sharing service and the interactions of the first users with the first channel, a score for each first user, wherein the determining of the score is improved by further using a ratio of views versus accesses for the shared content sourced from the third party system and presented via the first channel;
creating, by the processor, an audience for the first channel, the audience constituting a subset of the first users with a score above a predetermined threshold wherein, wherein the creating of the audience is improved by further selecting each user of the subset of the first users based on a number of channels for which each user is part of an audience; and
presenting, via a graphical user interface, (a) one or more video content items sourced from the content sharing service to any users of the plurality of users as part of the first channel, and (b) one or more shared content sourced from the third party system to users of the audience as part of the first channel.

10. The method according to claim 9, further comprising updating a size of the created audience at a predetermined time interval.

11. The method according to claim 10, further comprising iteratively recreating the audience based on an updated predetermined threshold.

12. The method according to claim 11, wherein the updated predetermined threshold is based on the first channel's budgetary restraint.

13. The method according to claim 12, wherein in response to the ratio being above the predetermined threshold, the updated predetermined threshold is made to be larger than the predetermined threshold, and
in response to the ratio being below the predetermined threshold, the updated predetermined threshold is made to be smaller than the predetermined threshold.

14. The method according to claim 9, further comprising:
determining that a number of channels for which a first user is part of an audience exceeds a threshold number of channels;
identifying which channels of the plurality of channels the first user is part of the audience to responsive to determining that the number of channels for which the first user is part of the audience exceeds the threshold number of channels.

15. The method according to claim 14, wherein the channels for which the first user is part of the audience are identified based on a revenue determination per channel.

16. The method according to claim 15, wherein the revenue determination per channel is based on a cost-per-click of the channel's shared content, the score of the first user for the channel, and ratio of a number of views of the first users of the channel and a number of accesses of the first users of the channel.

17. A method comprising:
providing a plurality of channels available to be viewed by any users of a plurality of users of a content sharing service;
analyzing, by a processor, interactions of an audience created for a channel of the plurality of channels of the content sharing service over a time period based on first users of the plurality of users of the content sharing service, the content sharing service comprising the plurality of channels, the plurality of channels comprising video content uploaded to the content sharing service by second users of the plurality of users and at least one of the first users of the plurality of users of the content sharing service for presentation to the first users of the content sharing service, the channel presenting video content items sourced from the content sharing service and shared content sourced from a third party system, the interactions comprising viewing the shared content and bypassing the shared content being viewed;
determining, by the processor, a ratio of views versus accesses for the created audience in response to the created audience being served the shared content from the channel;
re-adjusting a size of the created audience based on the determination wherein the re-adjusting of the size of the created audience is further improved based on a number of channels for which each user is part of an audience; and
presenting, via a graphical user interface, (a) one or more video content items sourced from the content sharing service to any users of the plurality of users as part of the first channel, and (b) one or more shared content sourced from the third party system to users of the audience as part of the first channel.

18. The method according to claim 17, wherein the size is made larger based on the ratio being above a predetermined threshold.

19. The method according to claim 17, wherein the size is made smaller based on the ratio being below a predetermined threshold.

20. The method according to claim 17, wherein the size is kept the same based on the ratio being within a range of a predetermined threshold.
